(19) United States
(12) Patent Application Publication
(10) Pub. No.: US 2007/0168937 A1
(43) Pub. Date: Jul. 19, 2007

(54) Apparatus and method of application virtualization

(76) Inventor: Soummya Mallick, Fremont, CA (US)

Correspondence Address: SOUMMYA MALLICK, 45300 MEDICINE BOW CT., FREMONT, CA, 94539, US

(21) Appl. No.: 11/604,716

(22) Filed: Nov. 28, 2006

Related U.S. Application Data
(60) Provisional application No. 60/739,835, filed on Nov. 28, 2005.

(51) Int. Cl. G06F 9/44; G06F 9/45

(52) U.S. Cl. 717/106; 717/148

(57) ABSTRACT

An apparatus and method of application virtualization is disclosed. In one embodiment, a method includes automatically generating a virtual execution environment of an application-enabled drive, installing the virtual execution environment in user mode on a host system when the application-drive is electrically coupled to the host system, detecting any changes made to an operating system of the host system, and moving the virtual execution environment from the host system to the application-enabled drive when the application-enabled drive is electrically decoupled from the host system. A plurality of systems file modification of a host system may be detected due to an application installation. The plurality of systems file modification of the host system may be made by the application installation in the virtual execution environment. The plurality of systems file modification of the host system may be deleted when the application-enabled drive is electrically decoupled from the host system.

### FIELD OF TECHNOLOGY

This disclosure relates generally to the technical fields of software and/or hardware technology and, in one example embodiment, to an apparatus and/or method of User Mode application virtualization.

### BACKGROUND

To fully utilize a software application (e.g., Microsoft Word®, Excel®, PowerPoint®, Adobe® Acrobat Reader, Adobe® Photoshop, Warcraft, Starcraft, etc.), one may wish to use the software application anywhere and anytime; regardless of a machine being used to carry out an execution. While the software application (e.g., Microsoft Word®, Excel®, PowerPoint®, Adobe® Acrobat Reader, Adobe® Photoshop, Warcraft, Starcraft, etc.) is being installed, it may make modification to an operating system (e.g., Microsoft® Windows 98/ME/2000/XP, Unix, QNX, etc.). For example, the software application may make changes to a system file (e.g., a registry, a DLL file, a COM object, and/or a file report, etc.) of the operating system. Additionally, a software operation may make changes to the system file of the operating system during an execution of the software application. As a result, the software application may require the operating system being present on a same device as the software application was installed since a modification to the operating system may be necessary for functionality.

As a result of a dependency of the software application (e.g., Microsoft Word®, Excel®, PowerPoint®, Adobe® Acrobat Reader, Adobe® Photoshop, Warcraft, Starcraft, etc.) on the operating system (e.g., Microsoft® Windows 98/ME/2000/XP, Unix, QNX, etc.), a portability of the software application may be limited to a device with the operating system installed. Furthermore, significant slow down may be experienced by the operating system installed on a portable device (e.g., a memory card, a USB flash drive, an MP3 player, a digital camera, and/or a mobile phone, etc.) due to a management overhead and/or an inherent limitation in a connection speed to a host system. This may further result in slowing down the execution of the software application and cause a user to perform a time consuming task.

Additionally, the portable device based on a flash memory may only be able to withstand a certain number (e.g., approximately 10⁶ programming cycles) of erase-write cycles. The flash memory may lose its nonvolatile property after a block of the flash memory has been accessed (e.g., writes, rewrites, erases, and/or reads) the certain number of times resulting in device failure (e.g., device malfunction, loss of storage data, and/or loss of backup data etc.). As such, the portable devices (e.g., a memory card, a USB flash drive, an MP3 player, a digital camera, and/or a mobile phone) based on flash memory may be limited to storing static file (e.g., pictures, music, video, documents, etc.) that do not require a large amount of writes to be made to the flash memory.

### SUMMARY

An apparatus and method of application virtualization.

In one aspect, a method includes automatically generating a virtual execution environment of an application-enabled drive, installing the virtual execution environment on a host system in user mode, when the application-enabled drive is electrically coupled to the host system, detecting any changes made to an operating system of the host system, and moving the virtual execution environment from the host system to the application-enabled drive when the application-enabled drive is electrically decoupled from the host system.

In one embodiment, a plurality of systems file modification of the host system due to an application installation may be detected. The plurality of systems file modification of the host system made by the application installation in the virtual execution environment may be recorded. The plurality of systems file modification of the host system may be deleted when the application-enabled drive is electrically decoupled from the host system. Furthermore, an application image may be installed on the application-enabled drive upon the application installation and the application image may be a collection of a data installed by the application installation that does not require an operating system of the host system.

In another embodiment, the application installed on the application-enabled drive may be executed based on the application image and a number of systems file modification of the host system recorded on the virtual execution environment. A data of the application image and a data of the plurality of systems file modification of the host system recorded on the virtual execution environment may be merged to allow execution of the application installed on the application-enabled drive. In addition, a data of the application image and a data of the plurality of systems file modification of the host system recorded on the virtual execution environment may be unmerged when an application activity suspends.

In another aspect, a method includes recording a plurality of systems file modification of a host system during an installation of an application on an application-enabled drive when the application-enabled drive is operatively coupled to a host system, and retaining the plurality of systems file modification of the host system of the installation of the application on the application-enabled drive when the application-enabled drive is operatively decoupled to the host system.

In one embodiment, a plurality of recorded systems file modification may be automatically transferred between the host system and the application-enabled drive. The plurality of systems file modification may be applied to the host system when the application is executed from the application-enabled drive. The plurality of systems file modification of the host system of the application installation may be deleted when the application-enabled drive is operatively decoupled from the host system. In addition, an application image may be installed on the application-enabled drive upon the application installation.

In another embodiment, the plurality of recorded systems file modification of the host system may be accessible by the application installed on the application-enabled drive. A data of the plurality of recorded systems file modification may be temporarily merged with a data of the application image when the application is executed from the application-enabled drive. A data of the application image from a data of the plurality of recorded systems file modification may be removed when application activity suspends.

In another aspect, an apparatus of an application-enabled drive includes a flash memory as a nonvolatile storage, a manager module to detect a systems file modification of a host system during an application installation and to record the systems file modification of the host system on a virtual execution environment, and an application module to store a plurality of application images installed through the host system, and executable through the virtual execution environment. The virtual execution environment may be a block of code that detects and records system file modification of an application installation.

In one embodiment, the manager module may generate a virtual execution environment able to be installed on a host system to which the application-enabled drive is operatively coupled to. The virtual execution environment may be modifiable on the host system by an application installer. In addition, the virtual execution environment may be removable from the host system and transferable to the application-enabled drive when the application-enabled drive is operatively decoupled from the host system.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A is an example of an USB key capable of carrying a portable application to a computer, according to one embodiment.

FIG. 1B is an example of an SD card capable of carrying a portable application to a smart-PDA phone, according to one embodiment.

FIG. 2 is a system view of an application-enabled device that communicates with a host system and a user, according to one embodiment.

FIG. 3 is an exploded view of the application-enabled device of FIG. 1 having a manager module, a virtual execution environment, an application module having applications, a flash, and/or a DRAM, according to one embodiment.

FIG. 4 is an exploded view of the host system of FIG. 1 having an operating system including a registry database, a dynamic link library database, and/or a COM database, and/or the virtual execution environment, according to one embodiment.

FIG. 5 is a table view of content referenced by an application of a portable application execution, according to one embodiment.

FIG. 6 is an interaction diagram of a process flow between the user, the host system, the manager module, the virtual execution environment, and the application module of FIGS. 1-2, according to one embodiment.

FIG. 7 is a diagrammatic representation of a machine in the form of a data processing system within which a set of instructions, for causing the machine to perform any one or more of the methodologies discussed herein, may be executed, according to one embodiment.

FIG. 8 is a process flow chart of automatically generating a virtual execution environment of an application-enabled drive, according to one embodiment.

FIG. 9 is a process flow chart of recording a plurality of systems file modification of a host system during an installation of an application on an application-enabled drive when the application-enabled drive is operatively coupled to a host system, according to one embodiment.

Other features of the present embodiments will be apparent from the accompanying drawings and from the detailed description that follows.

### DETAILED DESCRIPTION

An apparatus and method of application virtualization is disclosed. In the following description, for the purposes of explanation, numerous specific details are set forth in order to provide a thorough understanding of the various embodiments. It will be evident, however to one skilled in the art that the various embodiments may be practiced without these specific details.

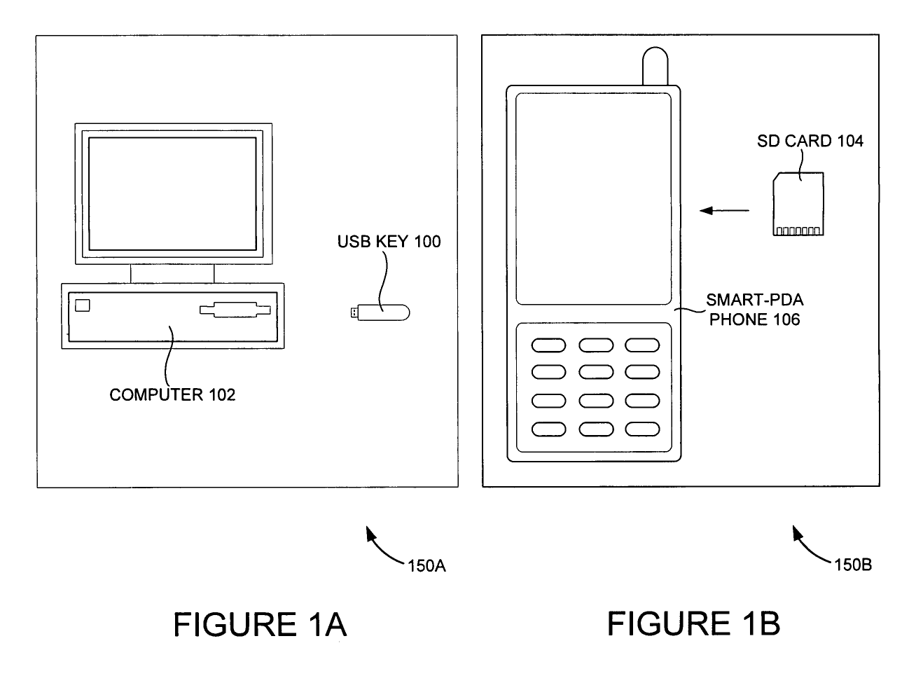

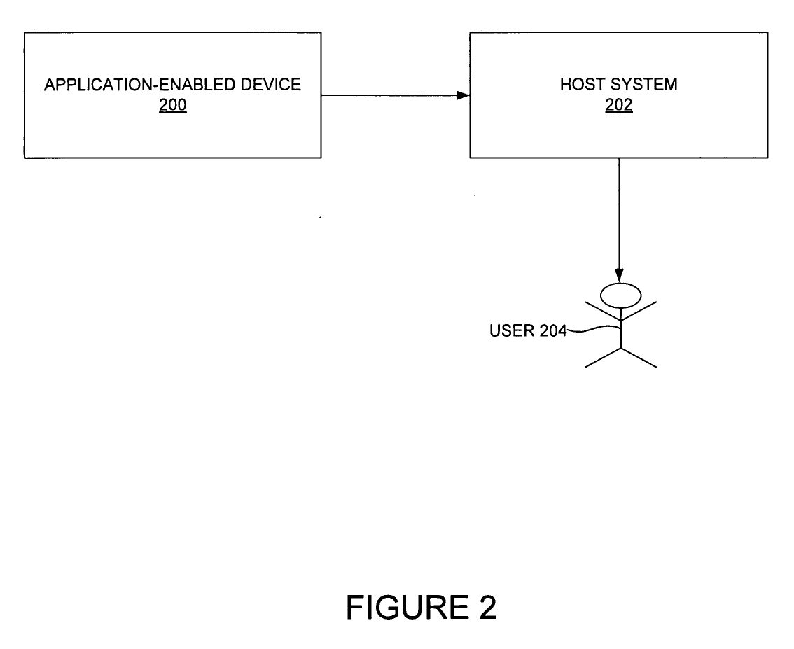

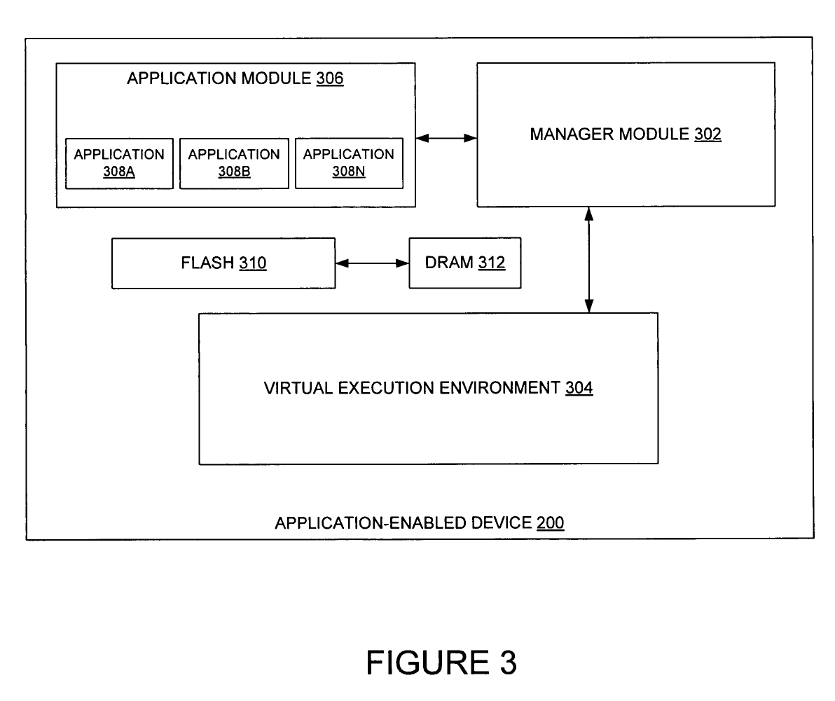

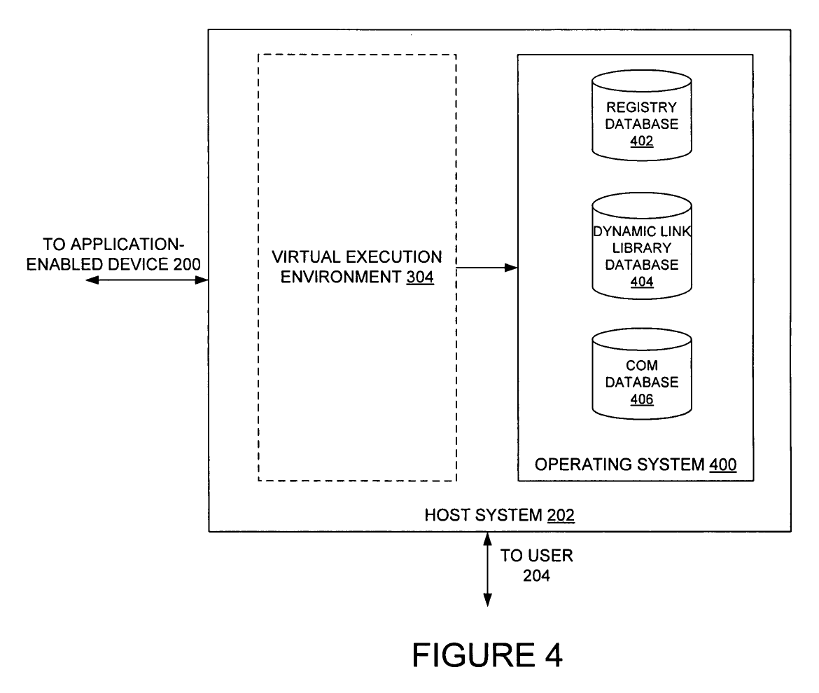

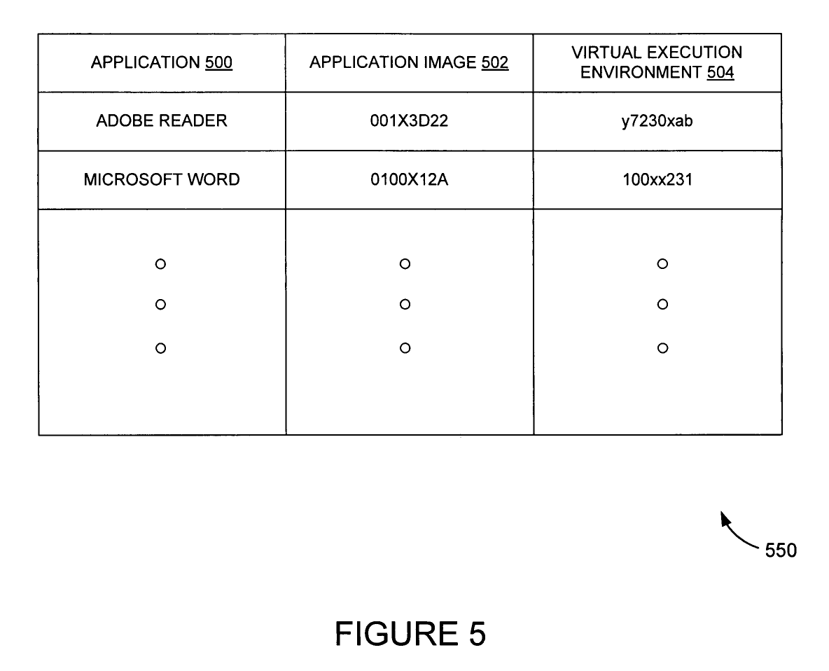

In one example embodiment, a virtual execution environment (e.g., a virtual execution environment 304 of FIGS. 3-4) of an application-enabled device (e.g., an application-enabled device 200 of FIGS. 1-2) is automatically generated, and the virtual execution environment (e.g., the virtual execution environment 304 of FIGS. 3-4) on a host system (e.g., a host system 202 of FIG. 2 and FIG. 3) when the application-enabled device (e.g., the application-enabled device 200 of FIGS. 1-2) is electrically coupled to the host system (e.g., the host system 202 of FIG. 2 and FIG. 3) is installed. Additionally, any changes made to an operating system (e.g., Microsoft® Windows 98/ME/2000/XP, Unix, QNX, etc.) of the host system host system (e.g., a host system 202 of FIG. 2) is detected, and the virtual execution environment (e.g., the virtual execution environment 304 of FIGS. 3-4) is moved from the host system (e.g., the host system 202 of FIG. 2) to the application-enabled device (e.g., the application-enabled device 200 of FIGS. 1-2) when the application-enabled device (e.g., the application-enabled device 200 of FIGS. 1-2) is electrically decoupled from the host system.

In a next example embodiment, a plurality of systems file modification of a host system (e.g., the host system 202 of FIG. 2) is recorded during an installation of an application on an application-enabled device (e.g., an application-enabled device 200 of FIGS. 1-2) when the application-enabled device (e.g., the application-enabled device 200 of FIGS. 1-2) is operatively coupled to a host system (e.g., the host system 202 of FIG. 2), and the plurality of systems file modification of the host system (e.g., a host system 202 of FIG. 2) of the installation of the application is retained on the application-enabled device (e.g., the application-enabled device 200 of FIGS. 1-2) when the application-enabled device (e.g., the application-enabled device 200 of FIGS. 1-2) is operatively decoupled to the host system (e.g., the host system 202 of FIG. 2).

In a further example embodiment, an application-enabled device(e.g., the application-enabled device 200 of FIGS. 1-2) includes a flash memory as a nonvolatile storage, a manager module to detect a systems file modification of a host system (e.g., a host system 202 of FIG. 2) during an application installation and to record the systems file modification of the host system (e.g., the host system 202 of FIG. 2) on a virtual execution environment (e.g., the virtual execution environment 304 of FIGS. 3-4), and an application module (e.g., an application module 306 of FIG. 3) to store a plurality of application images installed through the host system (e.g., the host system 202 of FIG. 2), and executable through the virtual execution environment (e.g., the virtual execution environment 304 of FIGS. 3-4) and wherein the virtual execution environment (e.g., the virtual execution environment 304 of FIGS. 3-4) is a block of code that detects and records system file modification of an application (e.g., Microsoft Word(®, Excel®, PowerPoint®, Adobe® Acrobat Reader, Adobe® Photoshop, Warcraft, Starcraft, etc.) installation.

FIG. 1A is an example of an USB key capable of carrying a portable application to a computer, according to one embodiment.

The USB key 100 (e.g., pen drive, chip stick, thumb drive, flash drive, etc.) may be a portable device (e.g., small, lightweight, removable, etc.) based on a flash-memory (e.g., NAND-type flash memory). The computer 102 may be personal computer (e.g., a PC, a MAC, etc.) with an operating system (e.g., Microsoft Windows®, Apple OS X®, Sun Solaris®, and/or Unix, etc.) and/or a central processing unit (e.g., an Intel Pentium®, an AMD athlon®, an Intel Centrino®, a PowerPC®, etc).

The USB key 100 (e.g., pen drive, chip stick, thumb drive, flash drive, etc.) may be electrically coupled to the computer 102 (e.g., a PC, a MAC, etc.). A user may access (e.g., store, delete, write, retrieve, rewrite, and/or read, etc.) a data in the USB key 100 (e.g., pen drive, chip stick, thumb drive, flash drive, etc.) through a file transfer operation through the computer 102 (e.g., a PC, a MAC, etc.). A user may carry the USB key 100 from the computer 102 to a different computer to access (e.g., store, delete, write, retrieve, rewrite, and/or read, etc.) a data in the USB key 100.

FIG. 1B is an example of an SD card capable of carrying a portable application to a smart-PDA phone, according to one embodiment.

The SD (e.g., secure digital) card 104 may be a portable device (e.g., small, lightweight, removable, etc.) based on a flash-memory (e.g., NAND-type flash memory). The smart-PDA phone 106 may be a portable intelligent device (e.g., a Palm® Pilot, a Blackberry®, and/or a Palm Trio®, etc.) and/or a personal digital assistant (e.g., a PDA) that integrates a functionality of a mobile phone, and/or the personal digital assistant (e.g., a PDA). The PDA may be a digital device which may include a functionality of a computer, a mobile phone, a music player, and/or a camera. The smart-PDA phone 106 may have an operating system (e.g., Palm® OS, Windows® Mobile, BREW, and/or Linux, etc.) and/or a central processing unit (e.g., the Intel Pentium®, a PowerPC®, etc).

The SD card 104 may be electrically coupled to the smart-PDA phone 106. A user may access (e.g., store, delete, write, retrieve, rewrite, and/or read, etc.) a data in the SD card 104 through a file transfer operation through the smart-PDA phone 106. A user may carry the SD card 104 from the smart-PDA phone 106 to a different smart-PDA phone to access (e.g., store, delete, write, retrieve, rewrite, and/or read, etc.) a data in the USB key 100.

FIG. 2 is a system view of an application-enabled device that communicates with a host system and a user, according to one embodiment.

The application-enabled device 200 may be a portable device (e.g., a USB key 100 of FIG. 1, an SD card 104 of FIG. 1, a thumb drive, a flash drive, a mini SD card, and/or a memory stick, etc.) using a flash memory as storage (e.g., a NAND type flash). The host system 202 of FIG. 2 may be a system with a processing capability (e.g., a personal computer (e.g., a PC, and/or a MAC, etc.), a digital camera, a smart phone, a PDA, a mobile phone, a smart-PDA phone, and/or a portable music player, etc.). The user 204 may be a person that uses the system with the processing capability (e.g., a personal computer (e.g., a PC, and/or a MAC, etc.), a digital camera, a smart phone, a PDA, a mobile phone, a smart-PDA phone, and/or a portable music player, etc.). The user 204 may also use the portable device (e.g., the USB key 100 of FIG. 1A, the SD card 104 of FIG. 1B, the thumb drive, the flash drive, the mini SD card, and/or the memory stick, etc.) to carry a data and/or and application (e.g., Microsoft Word®, Excel®, PowerPoint®, Adobe® Acrobat Reader, Adobe® Photoshop, Warcraft, Starcraft, etc.) from a location to another.

The application-enabled device 200 may be electrically coupled to the host system 202 of FIG. 2. A user 204 may access (e.g., store, delete, write, retrieve, rewrite, and/or read, etc.) a data in the application-enabled device 200 through a file transfer operation through the host system 202 of FIG. 2. The user 204 may carry the application-enabled device 200 from the host system 202 of FIG. 2 to a different host system to access (e.g., store, delete, write, retrieve, rewrite, and/or read, etc.) a data in the application-enabled device 200.

FIG. 3 is an exploded view of the application-enabled device 200 of FIG. 1 having a manager module 302, a virtual execution environment 304, an application module 306 having and application 308A, 308B, and/or 308N, etc., a flash 310, and/or a DRAM 312, according to one embodiment.

The application-enabled device 200 may be a portable device (e.g., a USB key 100 of FIG. 1, an SD card 104 of FIG. 1, a thumb drive, a flash drive, a mini SD card, and/or a memory stick, etc.) using a flash memory as storage (e.g., a NAND type flash). The manager module 302 may be a hardware and/or a software. The virtual execution environment 304 may be a hardware and/or a software implementation of an execution environment of an application. The application module 306 may be a hardware and/or software implementation of an application managing mechanism. The application 308A may be a hardware and/or a software implementation of an application image storage and/or management. The application 308B may be a hardware and/or a software implementation of an application image storage and/or management. The application 308C may be a hardware and/or a software implementation of an application image storage and/or management. The flash 310 may be a flash (e.g., NAND type flash) memory storage. The DRAM 312 may be a DRAM storage.

The manager module 302 may detect an operative coupling of the application-enabled device 200 to a host system (e.g., the host system 202 of FIG. 2). Thus, the manager module 302 may automatically install the virtual execution environment 304 on the host system 202 of FIG. 2 upon detecting the operative coupling of the application-enabled device 200 to the host system 202 of FIG. 2.

A user (e.g., the user 204 of FIG. 2) may install an application on the application-enabled drive 200 through the host system 202 of FIG. 2. When a user (e.g., the user 204 of FIG. 2) initiates an application installation from the host system 202 of FIG. 2, the virtual execution environment 304 may detect a change (e.g., a systems file modification of the host system 202 of FIG. 2) of an operating system of the host system 202 of FIG. 2. The change (e.g., the systems file modification of the host system 202 of FIG. 2) of the operating system of the host system 202 of FIG. 2 may further be recorded on the virtual execution environment 304. A log file of the operating system of the host system 202 of FIG. 2 may also be recorded. An application image (e.g., an application binary) of an installed application may be stored in the application 308A, 308B, and/or 308C of the application module 306. The flash 310 and the DRAM 312 may be used to store and/or backup data such that an efficient data access speed may be achieved.

When the application installation has been completed, the manager module 302 may delete the systems file modification of the host system 202 of FIG. 2 and transfer the virtual execution environment 304 to the application-enabled drive. When the application-enabled drive 200 is operatively coupled to another host system, the application previously installed from the host system 202 of FIG. 2 may be executed from the another host system by performing an install of the virtual execution environment 304. When the application-enabled drive 200 is operatively de-coupled from the other host system, the virtual execution environment 304 may be removed from the other host system.

In one embodiment, the manager module 302 may automatically generate a virtual execution environment (e.g., the virtual execution environment 304 of FIG. 3) of an application-enabled device (e.g., the application-enabled device 200). The virtual execution environment 304 may be installed on the host system (e.g., the host system 202 of FIG. 2) when the application-enabled device is electrically coupled to the host system 202 of FIG. 2. In addition, the manager module 203 may detect any changes (e.g., a systems file modification) made to the operating system of the host system 202 of FIG. 2. The manager module 302 may also move the virtual execution environment 304 from the host system 202 of FIG. 2 to the application-enabled device 200 of FIG. 2 when the application-enabled device 200 of FIG. 2 is electrically decoupled from the host system 202 of FIG. 2.

In another embodiment, the manager module 302 may detect a systems file modification of the host system 202 of FIG. 2 due to the application installation. The manager module 302 may also record the plurality of systems file modification of the host system 202 of FIG. 2 made by the application installation in the virtual execution environment 304. The manager module 302 may also delete the systems file modification of the host system 202 of FIG. 2 when the application-enabled device 200 is electrically decoupled from the host system 202 of FIG. 2. The manager module 302 may install an application image on the application-enabled device 200 upon the application installation wherein the application image may be a collection of a data installed by the application installation that does not require the operating system of the host system 202 of FIG. 2.

In addition, the manager module 302 may execute the application installed on the application-enabled device 200 of FIG. 2 based on the application image and the systems file modification of the host system 202 of FIG. 2 recorded on the virtual execution environment 304. The manager module 302 may merge a data of the application image and a data of the systems file modification of the host system 202 of FIG. 2 recorded on the virtual execution environment 304 to allow execution of the application installed on the application-enabled device 200 FIG. 2. Furthermore, the manager module 302 may unmerge a data of the application image and a data of the plurality of systems file modification of the host system recorded on the virtual execution environment 304 when an application activity suspends.

In another embodiment, the virtual execution environment 304 may record systems file modification of the host system 202 of FIG. 2 during an installation of an application on the application-enabled device 200 of FIG. 2 when the application-enabled device is operatively coupled to the host system 202 of FIG. 2. The virtual execution environment 304 may retain the plurality of systems file modification of the host system 202 of FIG. 2 of the installation of the application on the application-enabled device 200 of FIG. 2 when the application-enabled device 200 of FIG. 2 is operatively decoupled to the host system 202 of FIG. 2. In addition the virtual execution environment 304 may automatically transfer a plurality of recorded systems file modification between the host system 202 of FIG. 2 and the application-enabled device 200 of FIG. 2. The virtual execution environment 304 may apply the plurality of systems file modification to the host system 202 of FIG. 2 when the application is executed from the application-enabled device 200 of FIG. 2. When the application-enabled device is operatively decoupled from the host system 202 of FIG. 2, the virtual execution environment 304 may delete the plurality of systems file modification of the host system of the application installation.

In another embodiment, the virtual execution environment 304 may install an application image on the application-enabled device 200 of FIG. 2 upon the application installation. In addition, the plurality of recorded systems file modification of the host system 202 of FIG. 2 may be accessible by the application installed on the application-enabled device 200 of FIG. 2. A data of the plurality of recorded systems file modification may be temporarily merged with a data of the application image when the application is executed from the application-enabled device 200 of FIG. 2. A data of the application image from a data of the plurality of recorded systems file modification may be removed when application activity suspends.

In yet another embodiment, the application module 306 may store a plurality of application images installed through the host system 202 of FIG. 2, and executable through the virtual execution environment 304 and the virtual execution environment 304 may be a block of code that detects and records system file modification of an application installation. The virtual execution environment 304 may be modifiable on the host system 202 of FIG. 2 by an application installer. The virtual execution environment 304 may be removable from the host system 202 of FIG. 2 and transferable to the application-enabled device 200 of FIG. 2 when the application-enabled device 200 of FIG. 2 is operatively decoupled from the host system 202 of FIG. 2.

FIG. 4 is an exploded view of the host system of FIG. 1 having an operating system 400 including a registry database 402, a dynamic link library database 404, and/or a COM database 406, and/or the virtual execution environment 304, according to one embodiment.

The host system 202 of FIG. 2 may be a system with a processing capability (e.g., a personal computer such as a PC, and/or a MAC, a digital camera, a smart phone, a PDA, a mobile phone, a smart-PDA phone, and/or a portable music player, etc.).

The operating system 400 may be Microsoft® Windows 98/ME/2000/XP, Unix, and/or QNX. The virtual execution environment 304 of FIG. 3 may be a hardware and/or a software implementation of an execution environment of an application. The registry database 402 may be database which stores a setting and/or an option for the operating system 400 (e.g., Microsoft® Windows, and/or Windows® Mobile, etc.). The dynamic link library database 404 may be a database to store a dynamic link library. The dynamic link library may be an implementation of a shared library concept of the operating system 400 (e.g., Microsoft® Windows, and/or Windows® Mobile, etc.). The COM database 406 may be a database to store a collection of COM file. A COM file may be a type of executable file containing a code and/or a data.

The virtual execution environment 304 of FIG. 3 may be automatically installed on the host system 202 of FIG. 2 upon detecting the operative coupling of the application-enabled device 200 to the host system 202 of FIG. 2. A user (e.g., a user 204 of FIG. 2) may install an application on the application-enabled drive 200 through the host system 202 of FIG. 2. When the user (e.g., the user 204 of FIG. 2) initiates an application installation from the host system 202 of FIG. 2, the virtual execution environment 304 of FIG. 3 may detect a change (e.g., a systems file modification of the host system 202 of FIG. 2) of the operating system of the host system 202 of FIG. 2. The change (e.g., the systems file modification of the host system 202 of FIG. 2) of the operating system of the host system 202 of FIG. 2 may further be recorded on the virtual execution environment 304 of FIG. 3. A log file of the operating system of the host system 202 of FIG. 2 may also be recorded.

In one embodiment, the virtual execution environment 304 of FIG. 3 may record a plurality of systems file modification of the host system 202 of FIG. 2 during an installation of an application on the application-enabled device 200 when the application-enabled device is operatively coupled to the host system 202 of FIG. 2. The virtual execution environment 304 of FIG. 3 may retain the plurality of systems file modification of the host system 202 of FIG. 2 of the installation of the application on the application-enabled device 200 when the application-enabled device 200 is operatively decoupled to the host system 202 of FIG. 2. In addition the virtual execution environment 304 of FIG. 3 may automatically transfer a plurality of recorded systems file modification between the host system 202 of FIG. 2 and the application-enabled device 200. The virtual execution environment 304 of FIG. 3 may apply the plurality of systems file modification to the host system 202 of FIG. 2 when the application is executed from the application-enabled device 200. When the application-enabled device is operatively decoupled from the host system 202 of FIG. 2, the virtual execution environment 304 of FIG. 3 may delete the plurality of systems file modification of the host system of the application installation.

In another embodiment, the virtual execution environment 304 of FIG. 3 may install an application image on the application-enabled device 200 of FIGS. 2-3 upon the application installation. In addition, the plurality of recorded systems file modification of the host system 202 of FIG. 2 may be accessible by the application installed on the application-enabled device 200 of FIGS. 2-3. A data of the plurality of recorded systems file modification may be temporarily merged with a data of the application image when the application is executed from the application-enabled device 200 of FIGS. 2-3. A data of the application image from a data of the plurality of recorded systems file modification may be removed when application activity suspends.

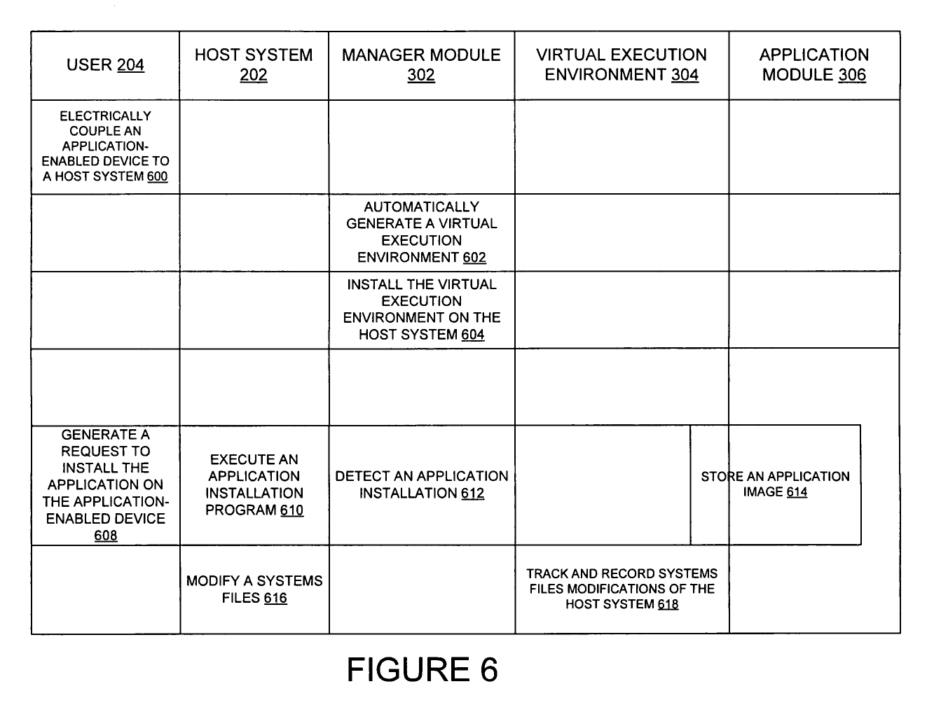

FIG. 5 is a table view of content referenced by an application 500 of a portable application execution, according to one embodiment.

The table 550 in FIG. 5 may include an application field 500, an application image field 502, and/or a virtual execution environment field 504.

The application field 500 may be a name and/or an identification tag associated with an application. The application image field 502 may be a reference index associated with an address of an application image on an application-enabled drive. The virtual execution environment field 504 may be a reference index associated with a location on the virtual execution environment.

For example, two applications are illustrated in FIG. 5 (e.g., ‘ADOBE READER’ and ‘MICROSOFT WORD’). The application ‘ADOBE READER’ has an application image field value ‘001x3D22’ indicating that reference index associated with the address of the application image on the application-enabled drive is ‘001x3D22’, a virtual execution environment field value ‘y7230xab’ indicating that the reference index associated with a location on the virtual execution environment is ‘y7230xab’. The application ‘MICROSOFT WORD’ has an application image field value ‘0100x12A’ indicating that reference index associated with the address of the application image on the application-enabled drive is ‘0100x12A’, a virtual execution environment field value ‘100xx231’ indicating that the reference index associated with a location on the virtual execution environment is ‘100xx231’.

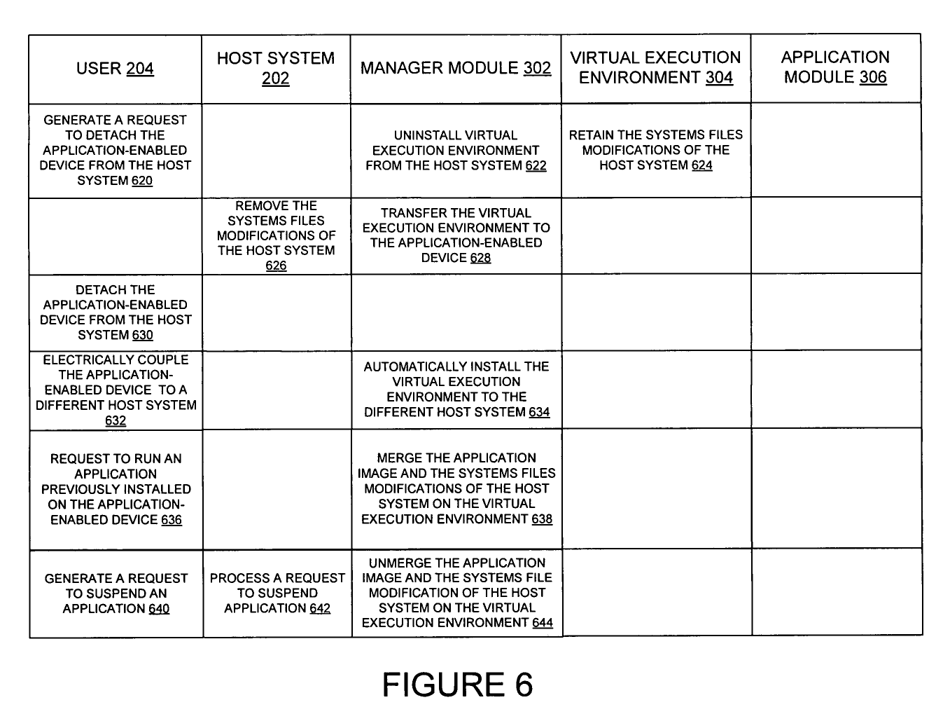

FIG. 6 is an interaction diagram of a process flow between the user 204, the host system 202 of FIG. 2, the manager module 302 of FIG. 3, the virtual execution environment 304 of FIG. 3, and the application module 306 of FIG. 3, according to one embodiment.

In operation 600, an application-enabled device is electrically coupled to a host system by the user 204. In operation 602, a virtual execution environment is automatically generated by the manager module 302. In operation 604, the virtual execution environment is installed oh the host system by the manager module 302. In operation 606, the manager module 302 waits for a user to install an application. In operation 608, a request to install an application on the application-enabled device is generated by the user 204. In operation 610, an application install program is executed by the host system 202. In operation 612, the application installation is detected by the manager module 302.

In operation 614, an application image is stored by the application module 306. In operation 616, a systems file is modified by the host system 202 of FIG. 2. In operation 618, the systems file modification of the host system is tracked and recorded by the virtual execution environment 304. In operation 620, a request to detach the application-enabled device from the host system is generated by the user 204. In operation 622, the virtual execution environment is executed from the host system by the manager module 302. In operation 624, the systems file modification of the host system is retained by the virtual execution environment 304. In operation 626, the systems file modification of the host system is removed by the host system 202. In operation 628, the virtual execution environment is transferred to the application-enabled device by the manager module 302. In operation 630, the application-enabled device is detached from the host system by the user 204.

In operation 632, the application-enabled device is electrically coupled to a different host system by the user 204. In operation 634, the virtual execution environment is automatically installed to the different host system. In operation 636, the user 204 requests to run an application previously installed on the application-enabled device. In operation 638, the application image and the system file modification of the host system on the virtual execution environment are merged by the manager module 302. In operation 640, a request suspend an application is generated by the user 204. In operation 642, a request to suspend the application is processed by the host system 202 of FIG. 2. In operation 644, the application image and the system file modification of the host system on the virtual execution environment is unmerged by the manager module 302.

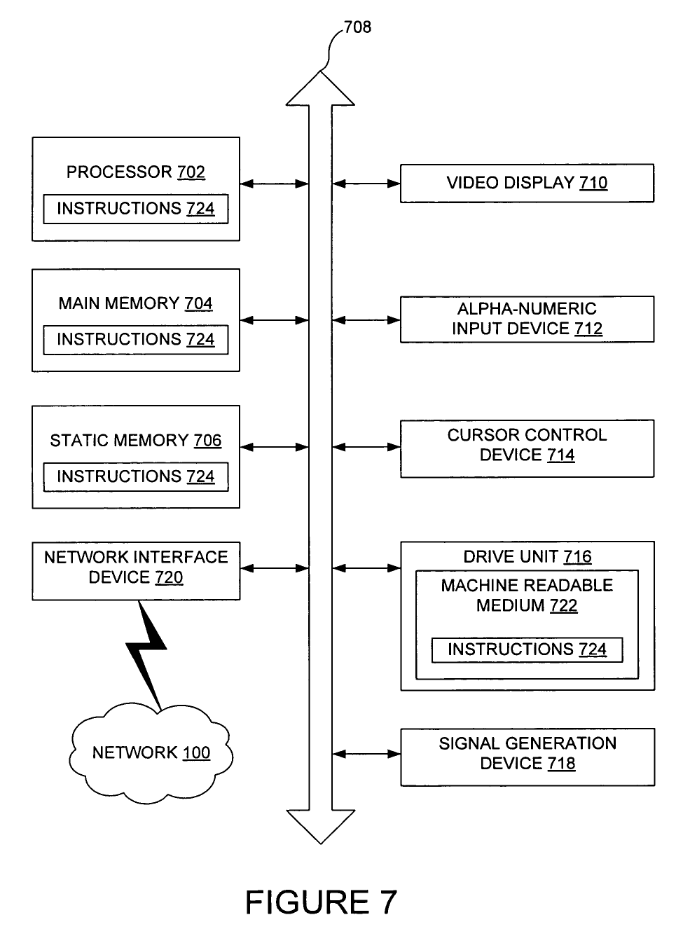

FIG. 7 is a diagrammatic representation of a machine in the form of a data processing system within which a set of instructions, for causing the machine to perform any one or more of the methodologies discussed herein, may be executed, according to one embodiment.

In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 700 includes a processor 702 (e.g., a central processing unit (CPU) a graphics processing unit (GPU) and/or both), a main memory 704 and a static memory 707, which communicate with each other via a bus 708. The computer system 700 may further include a video display unit 710 (e.g., a liquid crystal display (LCD) and/or a cathode ray tube (CRT)). The computer system 700 also includes an alphanumeric input device 712 (e.g., a keyboard), a cursor control device 714 (e.g., a mouse), a disk drive unit 717, a signal generation device 718 (e.g., a speaker) and a network interface device 720.

The disk drive unit 717 includes a machine-readable medium 722 on which is stored one or more sets of instructions (e.g., software 724) embodying any one or more of the methodologies and/or functions described herein. The software 724 may also reside, completely and/or at least partially, within the main memory 704 and/or within the processor 702 during execution thereof by the computer system 700, the main memory 704 and the processor 702 also constituting machine-readable media.

The software 724 may further be transmitted and/or received over a network 727 via the network interface device 720. While the machine-readable medium 722 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

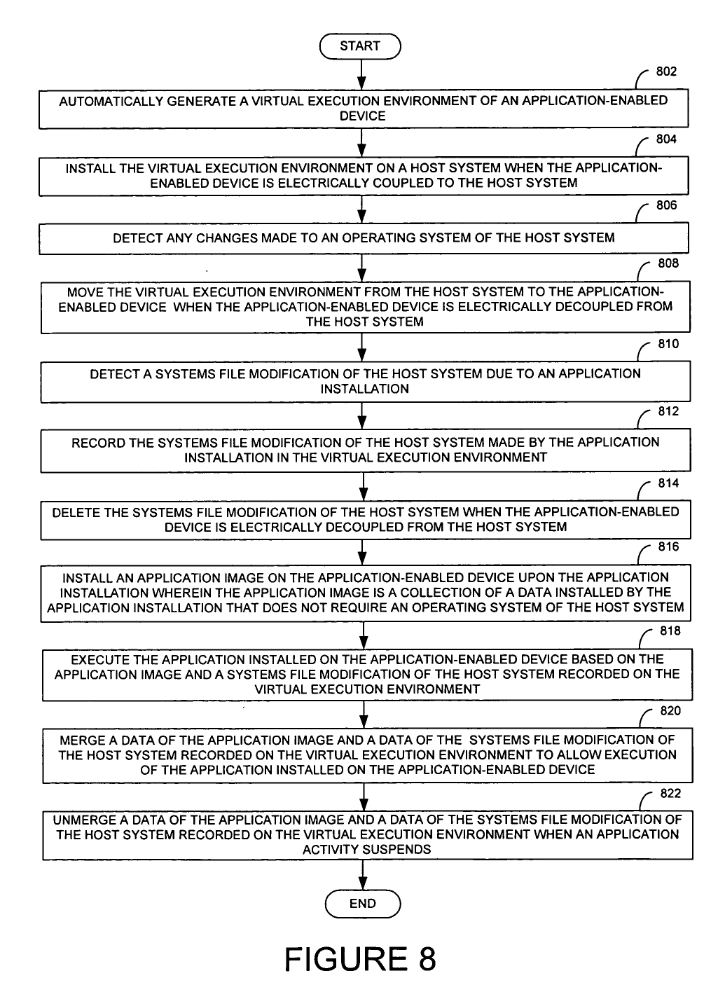

FIG. 8 is a process flow chart of automatically generating a virtual execution environment of an application-enabled device, according to one embodiment.

In operation 802, a virtual execution environment (e.g., the virtual execution environment 304 of FIGS. 3-4) of an application-enabled device (e.g., the application-enabled device 200 of FIGS. 1-2) may be automatically generated. In operation 804, the virtual execution environment (e.g., the virtual execution environment 304 of FIGS. 3-4) may be installed on a host system (e.g., a host system 202 of FIG. 2 and FIG. 3) when the application-enabled device (e.g., the application-enabled device 200 of FIGS. 1-2) is electrically coupled to the host system (e.g., the host system 202 of FIG. 2). In operation 807, any changes made to an operating system (e.g., Microsoft® Windows 98/ME/2000/XP, Unix, QNX, etc.) of the host system may (e.g., the host system 202 of FIG. 2) be detected. In operation 808, the virtual execution environment (e.g., the virtual execution environment 304 of FIGS. 3-4) may be moved from the host system (e.g., the host system 202 of FIG. 2) to the application-enabled device (e.g., the application-enabled device 200 of FIGS. 1-2) when the application-enabled device is electrically decoupled from the host system (e.g., the host system 202 of FIG. 2).

In operation 810, a systems file modification of the host system (e.g., the host system 202 of FIG. 2) may be detected due to an application installation. In operation 812, the systems file modification of the host system made (e.g., the host system 202 of FIG. 2) by the application installation may be recorded in the virtual execution environment (e.g., the virtual execution environment 304 of FIGS. 3-4). In operation 814, the systems file modification of the host system (e.g., the host system 202 of FIG. 2) may be deleted when the application-enabled device (e.g., the application-enabled device 200 of FIGS. 1-2) is electrically decoupled from the host system.

In operation 817, an application image may be installed on the application-enabled device (e.g., the application-enabled device 200 of FIGS. 1-2) upon the application installation wherein the application image is a collection of a data installed by the application installation that does not require an operating system (e.g., Microsoft® Windows 98/ME/2000/XP, Unix, QNX, etc.) of the host system (e.g., the host system 202 of FIG. 2). In operation 818, the application installed on the application-enabled device (e.g., the application-enabled device 200 of FIGS. 1-2) may be executed based on the application image and the systems file modification of the host system (e.g., the host system 202 of FIG. 2) recorded on the virtual execution environment (e.g., the virtual execution environment 304 of FIGS. 3-4).

In operation 820, a data of the application image and a data of the systems file modification of the host system (e.g., the host system 202 of FIG. 2) recorded on the virtual execution environment (e.g., the virtual execution environment 304 of FIGS. 3-4) may be merged to allow execution of the application installed on the application-enabled device (e.g., the application-enabled device 200 of FIGS. 1-2). In operation 822, a data of the application image and a data of the systems file modification of the host system (e.g., the host system 202 of FIG. 2) recorded on the virtual execution environment (e.g., the virtual execution environment 304 of FIGS. 3-4) may be unmerged when an application activity suspends.

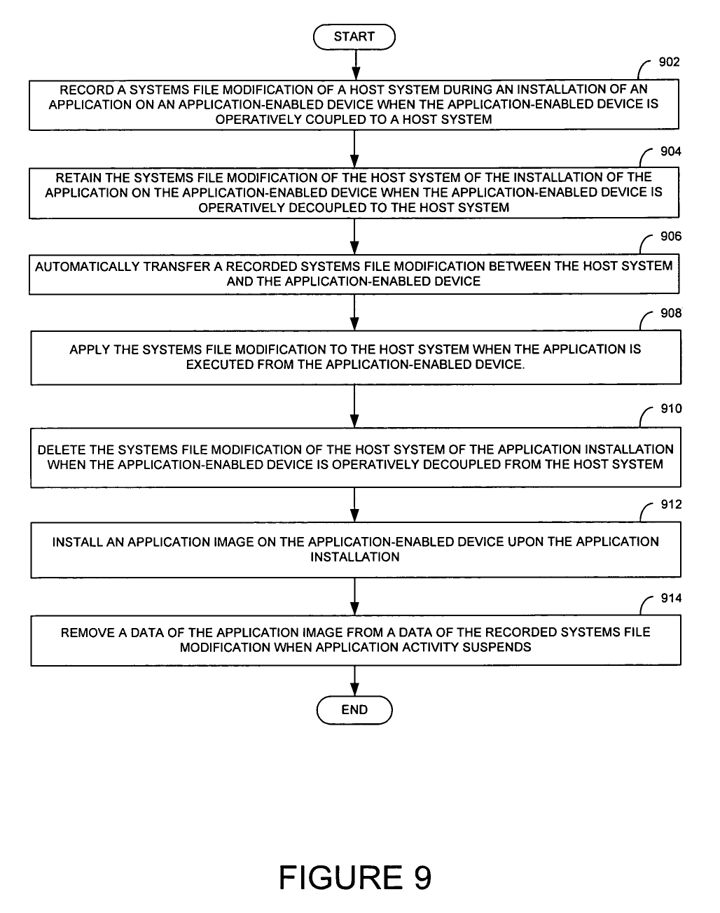

FIG. 9 is a process flow chart of recording a systems file modification of a host system (e.g., the host system 202 of FIG. 2) during an installation of an application (e.g., Microsoft Word®, Excel®, PowerPoint®, Adobe® Acrobat Reader, Adobe® Photoshop, Warcraft, Starcraft, etc.) on an application-enabled device (e.g., the application-enabled device 200 of FIGS. 1-2) when the application-enabled device (e.g., the application-enabled device 200 of FIGS. 1-2) is operatively coupled to a host system (e.g., the host system 202 of FIG. 2), according to one embodiment. In operation 902, the systems file modification of a host system (e.g., the host system 202 of FIG. 2) during an installation of an application (e.g., Microsoft Word®, Excel®, PowerPoint®, Adobe® Acrobat Reader, Adobe® Photoshop, Warcraft, Starcraft, etc.) may be recorded on an application-enabled device (e.g., the application-enabled device 200 of FIGS. 1-2) when the application-enabled device (e.g., the application-enabled device 200 of FIGS. 1-2) is operatively coupled to a host system.

In operation 904, the systems file modification of the host system (e.g., the host system 202 of FIG. 2) of the installation of the application (e.g., Microsoft Word®, Excel®, PowerPoint®, Adobes® Acrobat Reader, Adobe® Photoshop, Warcraft, Starcraft, etc.) may be retained on the application-enabled device (e.g., the application-enabled device 200 of FIGS. 1-2) when the application-enabled device (e.g., the application-enabled device 200 of FIGS. 1-2) is operatively decoupled to the host system (e.g., the host system 202 of FIG. 2). In operation 907, a recorded systems file modification may be automatically transferred between the host system (e.g., the host system 202 of FIG. 2) and the application-enabled device (e.g., the application-enabled device 200 of FIGS. 1-2).

In operation 908, the systems file modification to the host system (e.g., the host system 202 of FIG. 2) may be applied. When the application is executed from the application-enabled device (e.g., the application-enabled device 200 of FIGS. 1-2). In operation 910, the systems file modification of the host system (e.g., the host system 202 of FIG. 2) of the application installation may be deleted when the application-enabled device (e.g., the application-enabled device 200 of FIGS. 1-2) is operatively decoupled from the host system (e.g., the host system 202 of FIG. 2). In operation 912, an application image may be installed on the application-enabled device (e.g., the application-enabled device 200 of FIGS. 1-2) upon the application installation. In operation 914, a data of the application image may be removed from a data of the recorded systems file modification when application activity suspends.

Although the present embodiments have been described with reference to specific example embodiments, it will be evident that various modification and changes may be made to these embodiments without departing from the broader spirit and scope of the various embodiments. For example, the various devices, modules, analyzers, generators, described herein may be enabled and operated using hardware circuitry (e.g., CMOS based logic circuitry), firmware, software and/or any combination of hardware, firmware, and/or software (e.g., embodied in a machine readable medium).

For example, the manager module 302, the virtual execution environment 304, and/or the application module 306, may be enabled using transistors, logic gates, and electrical circuits (e.g., application specific integrated ASIC circuitry) using a manager circuit, a virtual execution environment circuit, and/or an application circuit.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

1. A method, comprising:
automatically generating a virtual execution environment of an application-enabled drive;
installing the virtual execution environment in user mode on a host system when the application-enabled drive is electrically coupled to the host system;
detecting any changes made to an operating system of the host system; and
moving the virtual execution environment from the host system to the application-enabled drive when the application-enabled drive is electrically decoupled from the host system.

2. The method of claim 1 further comprising detecting a plurality of systems file modification of the host system due to an application installation.

3. The method of claim 2 further comprising recording the plurality of systems file modification of the host system made by the application installation in the virtual execution environment.

4. The method of claim 1 further comprising deleting the plurality of systems file modification of the host system when the application-enabled drive is electrically decoupled from the host system.

5. The method of claim 1 further comprising installing an application image on the application-enabled drive upon the application installation wherein the application image is a collection of a data installed by the application installation that does not require an operating system of the host system.

6. The method of claim 5 further comprising executing the application installed on the application-enabled drive based on the application image and a plurality of systems file modification of the host system recorded on the virtual execution environment.

7. The method of claim 7 further comprising merging a data of the application image and a data of the plurality of systems file modification of the host system recorded on the virtual execution environment to allow execution of the application installed on the application-enabled drive.

8. The method of claim 7 further comprising unmerging a data of the application image and a data of the plurality of systems file modification of the host system recorded on the virtual execution environment when an application activity suspends.

9. A method, comprising:
recording a plurality of systems file modification of a host system during an installation of an application on an application-enabled drive when the application-enabled drive is operatively coupled to a host system; and
retaining the plurality of systems file modification of the host system of the installation of the application on the application-enabled drive when the application-enabled drive is operatively decoupled to the host system.

10. The method of claim 9 further comprising automatically transferring a plurality of recorded systems file modification between the host system and the application-enabled drive.

11. The method of claim 10 further comprising applying the plurality of systems file modification to the host system when the application is executed from the application-enabled drive.

12. The method of claim 11 further comprising deleting the plurality of systems file modification of the host system of the application installation when the application-enabled drive is operatively decoupled from the host system.

13. The method of claim 9 further comprising installing an application image on the application-enabled drive upon the application installation.

14. The method of claim 9 wherein the plurality of recorded systems file modification of the host system is accessible by the application installed on the application-enabled drive.

15. The method of claim 14 wherein a data of the plurality of recorded systems file modification is temporarily merged with a data of the application image when the application is executed from the application-enabled drive.

16. The method of claim 7 further comprising removing a data of the application image from a data of the plurality of recorded systems file modification when application activity suspends.

17. An apparatus of an application-enabled drive, comprising:
a flash memory as a nonvolatile storage;
a manager module to detect a systems file modification of a host system during an application installation and to record the systems file modification of the host system on a virtual execution environment; and
an application module to store a plurality of application images installed through the host system, and executable through the virtual execution environment and wherein the virtual execution environment is a block of code that detects and records system file modification of an application installation.

18. The apparatus of claim 17 further comprising the manager module generating a virtual execution environment able to be installed on a host system to which the application-enabled drive is operatively coupled to.

19. The apparatus of claim 18 wherein the virtual execution environment is modifiable on the host system by an application installer.

20. The apparatus of claim 19 wherein the virtual execution environment is removable from the host system and transferable to the application-enabled drive when the application-enabled drive is operatively decoupled from the host system.
